(19) United States
(12) Patent Application Publication
(10) Pub. No.: US 2015/0206239 A1
(43) Pub. Date: Jul. 23, 2015

(54) PROCESSOR AND A METHOD FOR PROCESSING A RECEIVED ORDER

(71) Applicant: BOOBERA LAGOON TECHNOLOGY, LLC, Chicago, IL (US)

(72) Inventors: Matthew John Hurd, Belrose NSW (AU); Scott Thomas Newham, Chatswood NSW (AU)

(21) Appl. No.: 14/416,891

(22) PCT Filed: Jul. 24, 2013
(86) PCT No.: PCT/AU2013/000813

§ 371 Date: Jan. 23, 2015

(30) Foreign Application Priority Data
Jul. 24, 2012 (AU) 2012903148

(51) Int. Cl. G06Q 40/04

(52) U.S. Cl. CPC G06Q 40/04

(57) ABSTRACT

Disclosed herein is a processor for processing order information indicative of an order. The processor is arranged to generate executability information indicative of the executability of at least part of the order using the order information. The processor is arranged to receive the order executability information and send a response to the order, the response comprising the order executability information. The processor is arranged to receive the order executability information and arranged to execute the at least part of the order if the order executability information indicates that the order is at least in part executable.

### TECHNICAL FIELD

The disclosure herein generally relates to a processor and a method for processing order information indicative of an order.

### BACKGROUND

Reducing the time taken for a system to send a response to an electronic message sent over an electronic network may be, in some circumstances, an important and generally overlooked determinant of commercial advantage. For example, a trader that receives a response to a financial order sent to a market may be able to act before a competitor of the trader. Favourable prices for financial instruments such as shares, derivatives and futures may then be taken advantage of before the competitor is able to. Fast responses may also provide a competitive advantage to an individual playing a networked electronic game, a gambling individual, and an individual taking part in an auction. Generally, speed of response may be important in any competitive electronic environment.

### SUMMARY

Disclosed herein is a processor for processing order information indicative of an order. The processor is arranged to generate executability information indicative of the executability of at least part of the order using the order information. The processor is arranged to receive the order executability information and send a response to the order, the response comprising the order executability information. The processor is arranged to receive the order executability information and arranged to execute the at least part of the order if the order executability information indicates that the order is at least in part executable.

In an embodiment, the processor is arranged to receive the order executability information and arranged to execute the at least part of the order after the sending of the response if the order executability information indicates that the order is at least in part executable.

In an embodiment, the processor comprises an order executability determiner arranged to generate executability information indicative of the executability of at least part of the order using the order information. The processor may comprise a response sender arranged to receive the order executability information and send a response to the order, the response comprising the order executability information. The processor may comprise an order executer arranged to receive the order executability information and arranged to execute the at least part of the order after the sending of the response if the order executability information indicates that the order is at least in part executable. Generally, the response is sent out before execution of the order to inform a client that made the order an outcome of the order with relatively little delay. The sending of the response may not be delayed, for example, by execution or by listing the order in a register of pending orders (the “order book”) at a market. This may enable the client to act more quickly and so gain advantage in the market. For example, a client may be able to follow a successful buy or sell order very quickly with another order to take advantage of a price difference between markets. Examples of a client include but are not limited to a trader and a broker, or a computer system under their control.

In the context of this specification, the meaning of order should be understood to encompass any one of a command, direction and instruction, including an instruction to any one of buy a financial instrument, an instruction to sell a financial instrument, and an instruction to cancel a pending order for a financial instrument. Alternatively, the order may be, for example, a domain name order, an electronic commercial transaction order, an order to place a wager or bid, or generally any order. Examples of financial instruments include but are not limited to shares, derivatives, and foreign currency.

An embodiment comprises memory having a pending order data structure. The pending order data structure may have pending order information indicative of a plurality of pending orders. The order executability determiner may be arranged to interrogate the pending order data structure to determine if the order can be matched with at least one of the plurality of pending orders. The pending order data structure may comprise a pending order queue. The pending order information may be ordered to prioritise the pending orders. The pending order data structure may comprise a price index indicative of a plurality of possible order prices. The pending order data structure may associate each of the plurality of pending orders to one of the plurality of possible order prices. The pending order data structure may have a doubly linked list data structure having the pending order information. The doubly linked list may comprise a plurality of nodes, each of the plurality of nodes being indicative of one of the plurality of orders. Those of the nodes being indicative of identically priced orders may be grouped together. The price index may comprise at least one of an array, a vector, a forward list and a doubly linked list having the plurality of possible order prices. The doubly linked list may be replaced with any suitable data structure, examples of which include an array, a vector, and a forward list.

The use of a pending order queue may result in a relatively faster interrogation of the pending order data structure which may consequently reduce the time taken to send the response. This may allow a client to act more quickly. The pending order data structure need not comprise a queue, however. The pending order data structure may comprise a database, for example.

In an embodiment the order executer is arranged to modify the pending order information. The order executer may comprise a pending order data structure modifier arranged to modify the pending order data structure. The pending order data structure modifier may be arranged to modify the pending order information to remove indications therein of a pending order that has been one of matched and cancelled. The data structure modifier may be arranged to modify the pending order information to reduce the number of an instrument indicated by one of the plurality of pending orders.

An embodiment comprises an order information receiver arranged to receive the order information.

Disclosed herein is a processor. The processor comprises an order information receiver arranged to receive order information indicative of a plurality of orders. The processor comprises an order distributer and a plurality of sub processors, the order distributor being arranged to distribute the plurality of orders to the plurality of sub processors which are cooperatively arranged to concurrently processes the plurality of orders.

In an embodiment, each of the sub processors may comprise an order executability determiner arranged to determine the executability of one of the plurality of orders received thereby. Each of the plurality of sub processors may comprise a response sender arranged to send a response to the one of the plurality of orders received thereby, the response indicating that the one of the plurality of orders received thereby is at least in part executed and not executable. The processor may comprises an order executer arranged to execute those of the plurality of orders that have been determined to be at least in part executable after sending of their respective response. A client of the processor, for example any one of a trader, broker or their computer, that sends multiple concurrent orders, or multiple orders in rapid succession, to the processor may be informed of their outcome relatively quickly by the processor and may be able to act quickly in response. This may improve the client's competitiveness.

An embodiment comprises an order information receiver arranged to receive the order information.

Disclosed herein is a system for processing order information indicative of at least one received order. The system comprises a plurality of processors in accordance with the above disclosure. The system comprises a processor fault monitor in communication with the plurality of processors. The processor fault monitor is arranged to detect a fault in one of the plurality of processors and subsequently enable at least one of the remaining of the plurality of processors.

An embodiment comprises an order information receiver arranged to receive the order information.

Disclosed herein is a method for processing order information indicative of an order. The method comprises the step of generating executability information indicative of the executability of at least part of the received order using the order information. The method comprises the step of sending a response to the order, the response comprising order executability information. The method comprises the step of executing the at least part of the order after sending the response if the order executability information indicates that the order is at least in part executable.

The method may comprise the step of interrogating a pending order data structure having pending order information indicative of a plurality of pending orders to determine if the order can be matched with at least one of the plurality of pending orders. The pending order data structure may comprise a pending order queue. The pending order information may be ordered to prioritise the pending orders. The pending order data structure may comprise a price index indicative of a plurality of possible order prices. The pending order data structure may associate each of the plurality of pending orders to one of the plurality of possible order prices. The pending order data structure may have a doubly linked list data structure having the pending order information. The doubly linked list may comprise a plurality of nodes, each of the plurality of nodes being indicative of one of the plurality of orders. Those of the nodes being indicative of identically priced orders may be grouped together. The price index may comprise at least one of an array, a vector, a forward list and a doubly linked list having the plurality of possible order prices. The doubly linked list may be replaced with any suitable data structure, examples of which include an array, a vector, and a forward list.

The pending order data structure need not comprise a queue, however. The pending order data structure may comprise a database, for example.

An embodiment comprises the step of modifying the pending order information. The step of modifying may comprise modifying the pending order information to remove indications therein of a pending order that has been one of matched and cancelled. The step of modifying may comprise modifying the pending order information to reduce the number of an instrument indicated by one of the plurality of pending orders.

An embodiment comprises the step of receiving the order information.

Disclosed herein is a method. The method comprises the step of receive order information indicative of a plurality of orders. The method comprises distributing the plurality of orders to the plurality of sub processors arranged to concurrently process the plurality of orders.

In an embodiment, the method comprises the step of determining the executability of the plurality of orders. The method may comprise sending a response to each of the plurality of orders, the response indicating that the respective order is at least in part executed and that the respective order is not executable. The method may comprise the step of executing each of the plurality of orders that have been determined to be at least in part executable after sending the respective response.

An embodiment comprises an order information receiver arranged to receive the order information.

Disclosed herein is a method for processing order information indicative of a received order. The method comprises monitoring for a fault in one of a plurality of processors that are each in accordance with the above disclosure. The method comprises the step of detecting a fault in the one of the plurality of processors and enabling at least one of the remaining of the plurality of processors.

An embodiment comprises an order information receiver arranged to receive the order information.

Disclosed herein is processor readable tangible media including program instructions which when executed by a processor causes the processor to perform a method in accordance with the above disclosure.

Disclosed herein is a computer program for instructing a processor which when executed by the processor causes the processor to perform a method in accordance with the above disclosure.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 shows an embodiment of a processor for processing received order information indicative of a received order.

FIG. 2 shows a flow diagram of an embodiment of a method for processing received order information that can be performed by the system of FIG. 1.

FIGS. 3 and 4 show schematic diagrams of two examples of pending order data structures that may be within the system of FIG. 1.

FIG. 5 shows a schematic diagram of another embodiment of a processor arranged to concurrently process a plurality of orders.

FIG. 6 shows a schematic diagram of an embodiment of a system for processing order information indicative of a received order.

FIG. 7 shows a schematic diagram of an example of a hardware architecture that may be used with either one of the processors of FIGS. 1, 5 and 6.

FIG. 8 shows a schematic diagram of another example a processor architecture that may be used with either one of processors of FIGS. 1, 5 and 6.

### DESCRIPTION OF EMBODIMENTS

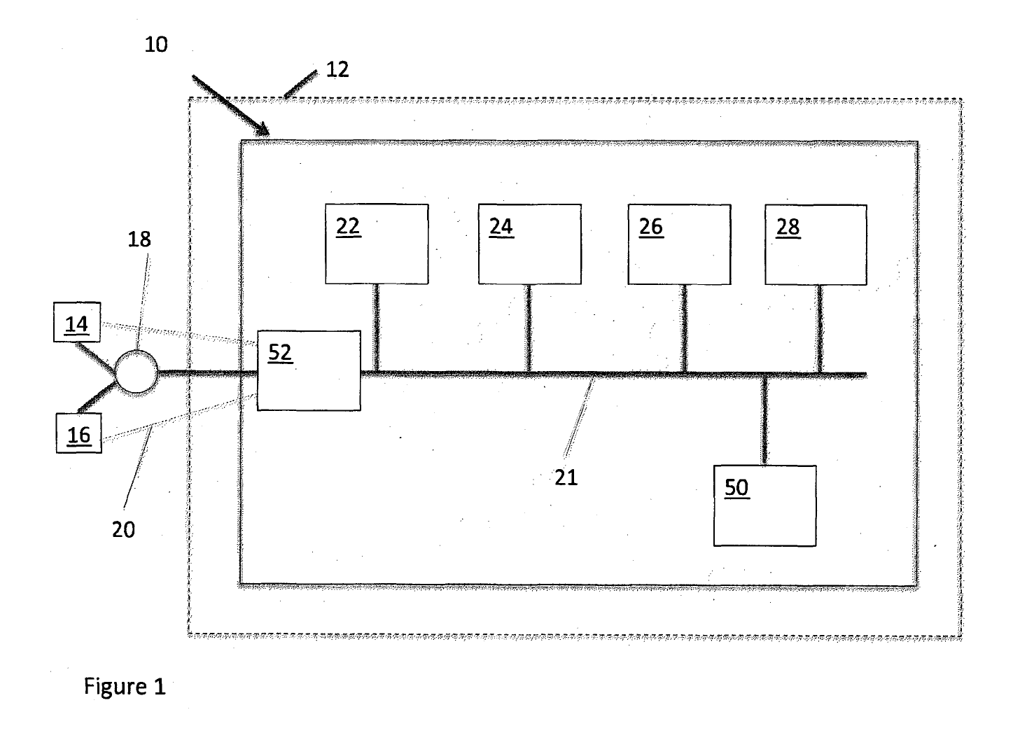

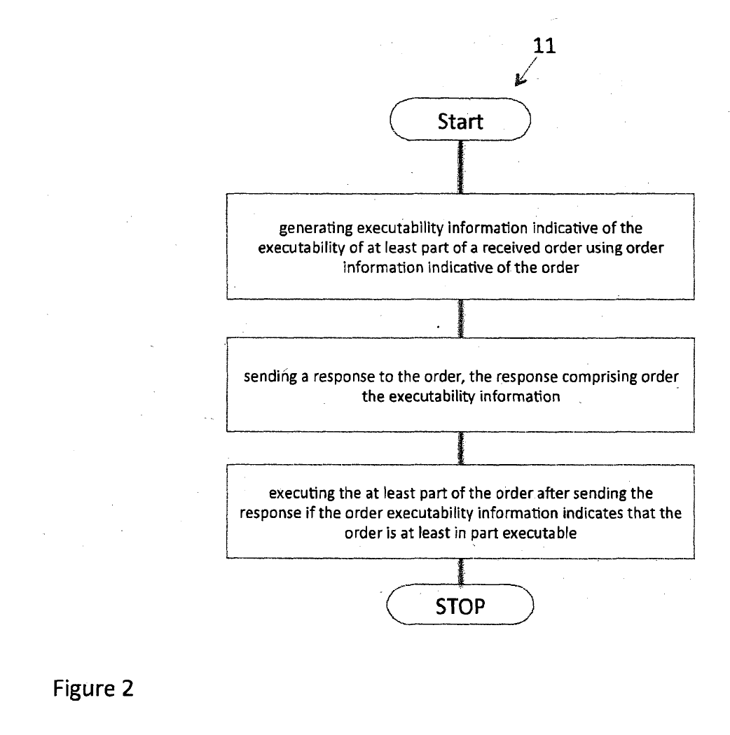

FIG. 1 shows an embodiment of a processor for processing received order information indicative of a received order, the processor being generally indicated by the numeral 10. FIG. 2 shows a flow diagram of an embodiment of a method 11 for processing received order information that can be performed by the system 10. The processor embodiment of FIG. 1 takes the form of a trade matching engine and is part of an electronic market 12 in the form of an electronic financial instrument exchange. The processor 10 is arranged to send a response to a received order before executing the order. Consequently, a client who made the received order receives the response relatively quickly and competitively.

The processor matches bids and offers to complete trades of financial instruments. The processor may use a price-time priority matching algorithm, or any other suitable matching algorithm. In a price-time priority algorithm those bids and offers entered into the processor first have priority over bids or offers that were subsequently entered at the same price.

Examples of financial instrument exchanges that the processor 10 may be used in include but are not limited to the New York Stock Exchange, and the Australian Securities Exchange. The electronic market may be any type of electronic market, however, an alternative example of which is an online auction service. In alternative embodiments, the processor is part of a gaming system, such as one that accepts wagers for horse races or other sporting events.

The electronic market 12 is in communication with a plurality of computers 14,16 over a network 18. The computers may be clients of the market 12 configured to create orders for transmission to the financial instrument exchange 12 via the network 18. Network 18 may be a local area network, for example. The local area network may, for example, comprise Ethernet, INFINIBAND, ISDN, WiFi or any other suitable network, or T1/E1 lines. Alternatively, network 18 may be the Internet. In other embodiments, the computers 14,16 may each have a one-to-one connection to the electronic market 12, via a serial, USB, Fire Wire, or Thunderbolt connection, or generally any suitable means. Example one-to-one connections are represented as dashed lines 20.

The system comprises a plurality of modules including those indicated by the numerals 22, 24, 26, 28, 50 and 52. The modules are, in this embodiment, in communication with each other over a bus 21. Module 52 is an order information receiver in the form of a network module that acts as an interface between the bus 21 and the network 18. Module 52 may also control the other module.

The system comprises an order executability determiner 22 arranged to determine the executability of the received order using the order information received from one of the clients 14,16 over the network 18 and via module 52. The system comprises a response sender 24. The order executability determiner generates order executability information indicating one of that the order is executable and that the order is not executable. The order executability determiner sends the order executability information via the bus 21 to the response sender. The executability information is received by the response sender which prepares a response to the received order information in the form of an electronic message. The electronic message is sent to the network interface 52 that sends the message. The message may take the form of a UDP segment, a TCP/IP packet, or generally any suitable form.

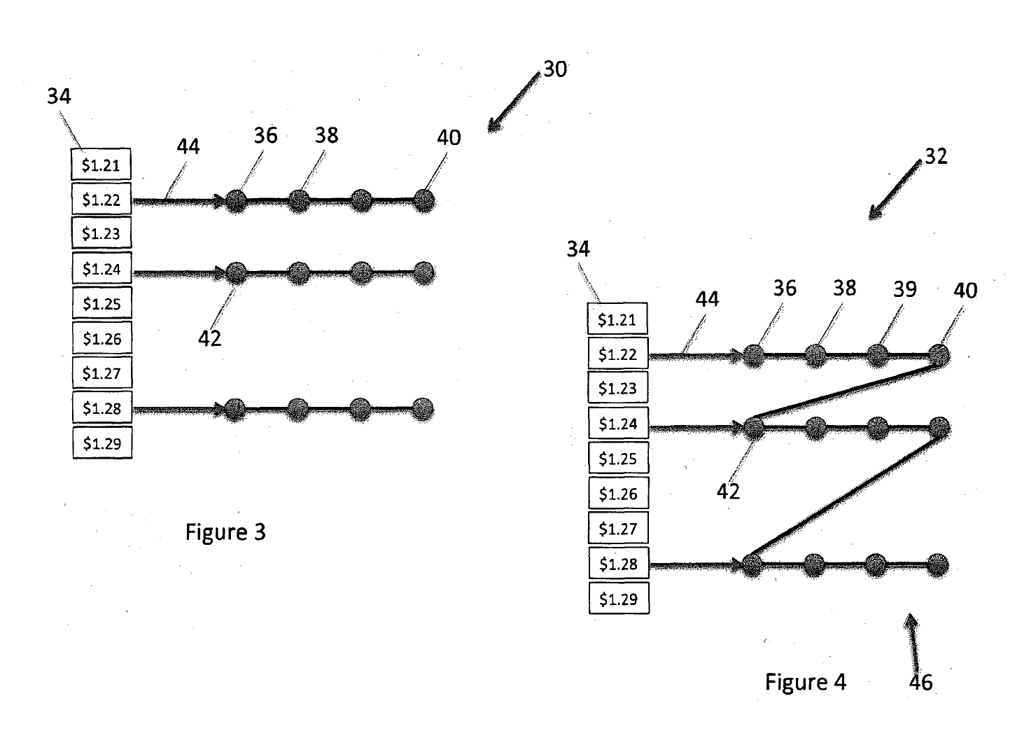

The system comprises an order executer 26 arranged to execute the order provided that the order is determined to be executable. The processor 12 has memory 28 in the form of Random Access Memory (RAM), although the memory may take any suitable form, for example a plurality of registers and FLASH. The memory 28 has at least one pending order data structure. Generally, however, the memory has a pending order data structure for pending buy orders (bids) and another pending order data structure for pending sell orders (offers). Each pending order data structure has information indicative of a plurality of buy or sell pending orders. For example, the pending order may have a symbol indicating the instrument indicated by the order (eg. BHP for shares in BHP Billiton Limited on the ASX), the number of instruments wanted or on offer (eg. 50000 instruments) and a identifier that can be used to identify the trader that made the order, for example. This information is represented in the pending order information. The pending order data structures may take any suitable form. For example, in one embodiment, the data structure may be in the form of a database. In other embodiments, the data structures may take the form of a priority queue. FIGS. 3 and 4 show schematic diagrams of two examples of pending order data structures 30,32, where elements of similar form or function are similarly numbered.

While the processor embodiment of FIG. 1 uses the pending order data structure 32, other embodiments may use the structure 30 or any other suitable data structure. The pending order data structure 32 comprises a price index 34 indicative of a plurality of possible order prices (in this example, the price index shows prices ranging from $1.21 to $1.29 for a share of a company, although the prices may be in any range and may indicate the price of any type of financial instrument, wager, or bid). The pending order data structure 32 has at least one of an array, vector, forward list and doubly linked list having the plurality of possible order prices. In this embodiment, the price index comprises an array, but any suitable alternative may be used.

The data structure 32 also has a doubly linked list 46 having the pending order information 36,38,40,42 indicative of a plurality of pending orders. Those of the plurality of pending orders that have an identical price are grouped together (For example, orders 36, 38, 39 and 40). Orders specifying the same price are arranged in the order in which they were received. The data structure 32 associates each of the plurality of pending orders to the plurality of possible order prices by using a pointer 44 linking a price to the first pending order received at the price. The prices are in the order in which they were received.

Generally but not necessarily, a doubly linked list is a linked data structure that consists of a set of sequentially linked records called nodes. Each node may contain two fields, called links, that are references to the previous and to the next node in the sequence of nodes. The beginning and ending nodes' previous and next links, respectively, point to some kind of terminator, typically a sentinel node or null, to facilitate traversal of the list. The, nodes also contain price information indicative of the price associated with the order (for example, sell at a price of $5.35 per share).

In an embodiment, the double linked list may be replaced with an array. In another embodiment, the doubly linked list may be replaced with an array or heap data structure, or generally any suitable data structure.

In embodiments in which the pending order data structure comprises a database, the pending order with the highest priority that matches the order may be found using a database query, for example.

It will be appreciated that the order information may be ordered in accordance with any other suitable type of priority. Examples of other types of priority include but are not limited to volume priority, and broker priority.

The order executability determiner 22 is arranged to interrogate the pending order data structure to determine if the order can be matched with at least one of the plurality of pending orders. The determination may be made in accordance with price-time priority or another type of priority. To match the order with a pending order, the order executability determiner may compare a price of the order with the price of a pending order. In one example, the order is a buy order. The order executability determiner may determine if there is a pending sell order at the trade matching engine that can be matched to the buy order. In other example, the order is a sell order. The order executability determiner may determine if there is a pending buy order at the trade matching engine that can be matched to the sell order. In both examples, a match may be made if the buy order specifies a threshold price that is at least one of equal to and greater than the price of a pending sell order. The determiner may use a different matching algorithm than that described above as appropriate for the order type. For example, a different algorithm may be used for midpoint passive liquidity orders, market orders and immediate or cancel (IOC) orders.

Further details on the general operation of the order executability determiner 22 will now be given. Generally, when order information is received by the processor 10, the price information is extracted therefrom. The order determiner will then determine that the order is executable, at least in part by retrieving price information from the first pending order of the list 46, that is the pending order at the best price. The order executability determiner, in this but necessarily in all embodiments may, if there are an insufficient number of instruments specified in the first pending order to fill the received order, proceed to at least one subsequent pending order, if any, in the doubly linked list 46 and determine if the received order can be filled. For some types of orders—for example an immediate or cancel (IOC) order—if the order cannot be completely executed then the order is determined to be not executable.

The processor 10 has a data structure modifier 50 arranged to modify the data structure in memory 28. Executability information generated by the executability determiner 22 is communicated to the data structure modifier 50. Nodes in the data structure indicative of pending orders that are matched at least in part are at least one of deleted and modified to indicate the number of remaining instruments after execution of the received order. Similarly, nodes in the data structure indicative of pending orders that are cancelled are removed from the doubly linked list 46.

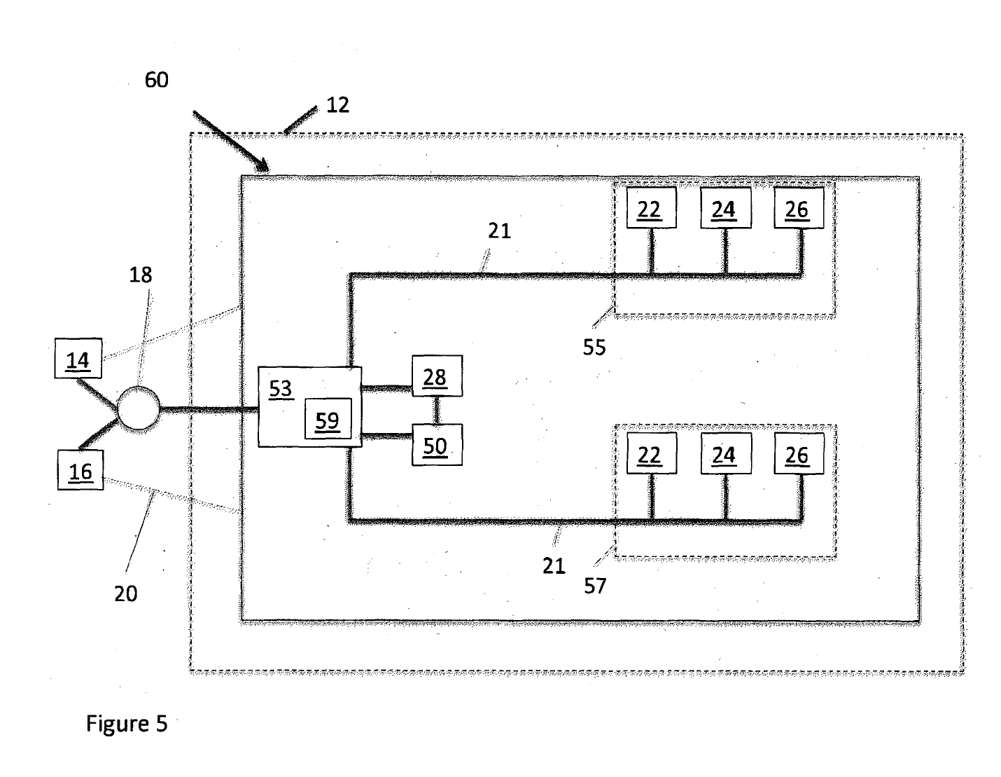

FIG. 5 shows a schematic diagram of another embodiment of a processor 60 arranged to concurrently process a plurality of orders, where parts similar and/or identical in form or function to parts of FIG. 1 are similarly numbered. The first order and the second order may be sent by at least one of the client 14,16 to the system 60 via the network 18. The orders may be sent in separate messages each in the form of at least one data packet. A control module 53 arranged to interface with the network 18 receives the plurality of orders. The system 60 has two similar or identical sub processors 55,57 indicated by the dashed boxes. Each of the sub processors 55,57 is in communication with the control module 53. The controller 53 may distribute a plurality of orders to the plurality of sub processors for concurrent processing. The sub processors each have a respective order executability determiner 22, response sender 24, order executer 26 which may each generally operate in accordance with the description above of their counterparts of FIG. 1. The sub processors may be in the form of dedicated hardware modules, software modules, different program threads or sub programs, and various combinations of hardware and software modules. Generally the sub processors may have any suitable form.

A first order when received is sent by the controller 53 to an idle one of the sub processors 55,57, which in this example is sub possessor 55. Sub processor 55 sends an acknowledgement of receipt of the order. The controller then sets a sub processor variable status variable in memory 28 to a logical 1 to indicate that the status of sub processor 55 is busy. The controller also writes to memory 28 instrument information indicative of the instrument indicated by the first order. A second received order maybe received while the sub processor 55 is busy processing the first order. If the order is not for the same instrument, stock or symbol (“instruments”), for example shares in BHP BILLITON, then the system 60 is able to process both orders concurrently by using the plurality of processors. The controller determines if the orders relate to different instruments, stocks or symbols, by comparing the instrument information retrieved from memory and extracted from the second order. If the instruments are found to differ, then the controller may attempt to cause the concurrent processing of the orders.

The controller inspects the status indicator and determines that sub processor 55 has a busy status but sub processor 57 has a status of not busy (which may be indicated by a logical 1, for example). The second order may thus be sent to sub processor 57. The executability determiner 22 of each sub processor 55 and 57 determine if their respectively received orders are at least in part executable, and if it is so determined, the respective response sender 24 sends a response to the respective received message via the controller 53, the message indicating that at least part of the order is executed. The sub processes also causes the controller to instruct a data structure modifier 50 in communication with the controller to modify the data structure in memory 28 to execute the pending order information in accordance with their partial or complete execution. For example, if a proportion of a specified number of instruments specified in a pending order are sold/bought, then the specified number of instruments is adjusted accordingly. If all of the specified number of instruments are bought/sold then the pending order is removed from the pending order data structure and the next, if any, order at the same price progresses in the queue. On receiving the response and/or instruction from one of the sub processors, the controller sets the status of the one of the sub processors to idle (logical 0). The controller 53 may have a buffer 59, for example a first-in-first out buffer, that buffers communications and instructions from the networks 18 and/or the sub processors 55,57. It will be appreciated that the system 60 may have more than the two sub processors shown in FIG. 9 so that more than two types of stock, instrument or symbol may be concurrently processed.

While in the above example the first and second orders where sent in separate messages it will be appreciated that the orders may alternatively be sent as a group or batched in one message. The one message may comprise at least one UDP segment, or TCP/IP data packet, for example, or may accord with any suitable protocol.

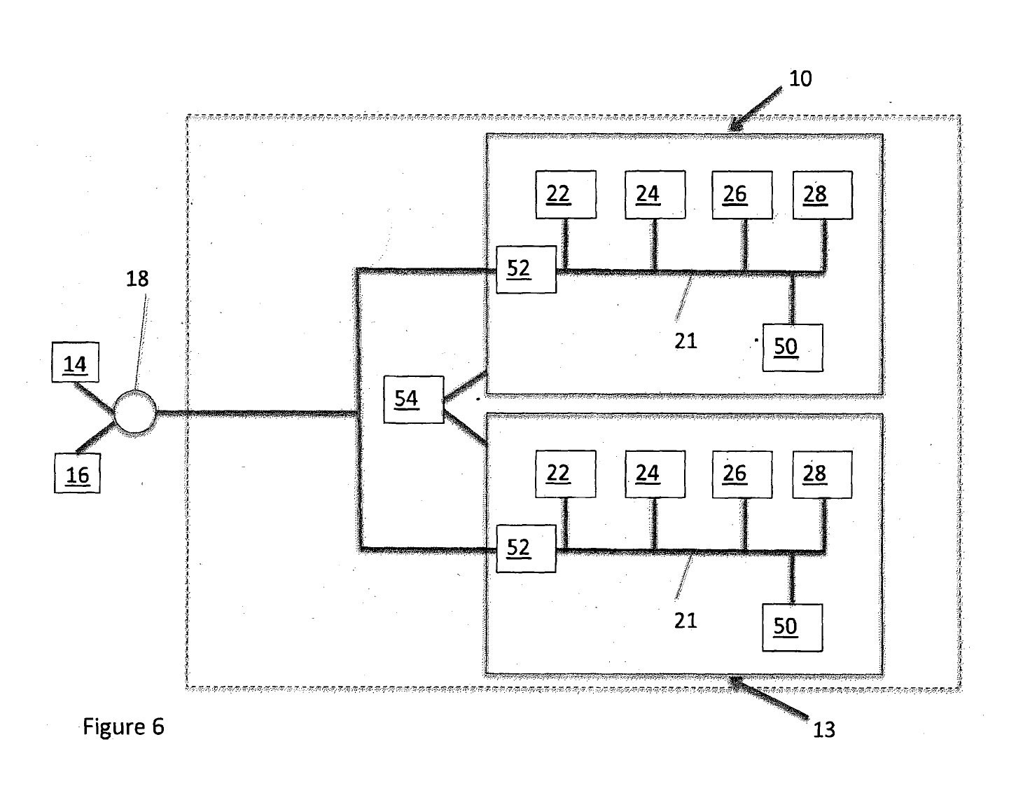

FIG. 6 shows a schematic diagram of a system for processing order information indicative of a received order. The system comprises at least two processors 10,13 processors each arranged to process the order information. In this but not necessarily in all embodiments, each of the processors 10,13 comprise a processor similar or identical to the embodiment shown in FIG. 1. Parts similar in form or function in FIGS. 1 and 5 are similarly numbered. When one of the processors fail the other one of the plurality of processors can process the order information as described above in relation to the embodiment of FIG. 1. Generally, the processors 10 and 13 are deterministic machines. Orders received via the network 18 broadcast to both processes by bus 23 in communication with coth processors. Consequently, the processors 10,13 have the same or very similar internal state at any moment. Generally, while both of the processors 10,13 are processing orders and updating pending order information structures therein, only one of the servers 10 is sending a response to the received order. This processor is enabled, while the other is effectively disabled. A fault monitor 54 in communication with the processor 10 via a conduit in the form of a communications cable monitors for a fault or failure in processor 10. If a fault or failure is detected it may instruct the processor 10 to suspend sending responses, or to shut down, and instruct processor 13 to start sending the responses, thus enabling it. The responses may be sequentially numbered, and processor 10 communicates the sequence number of responses as they are sent to the fault monitor. In the case of failure of processor 10, the fault monitor communicates the sequence number of the last sent response so that the processor 13 can start sending responses having sequence numbers immediately subsequent to the last sent response.

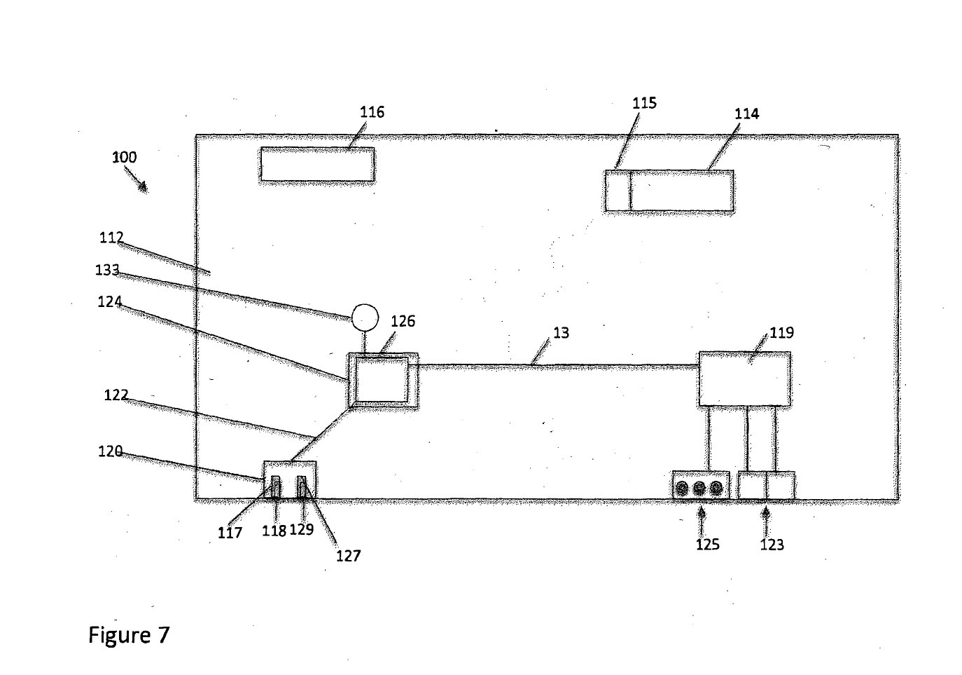

FIG. 7 shows a schematic diagram of an example of a hardware architecture 100 that may be used with either one of the processors of FIGS. 1, 5 and 6. The architecture has a multilayer printed circuit board 112 having components mounted thereto which generally, but not necessarily, are connected to each other by conductive pathways, which may comprise, for example, tracks, signal traces, strip lines and/or micro strip lines, and wires, as appropriate. Generally, but not necessarily, the printed circuit board 112 is housed by a rack mountable enclosure having dimensions of 1 rack unit, although any suitable enclosure may be used or not used as desired. The printed circuit board has various surface mounted and/or through hole components mounted thereto.

A mains supply 114 may be mounted to the printed circuit board 112, the mains supply in use producing a relatively low voltage, such as 12, 24 or 48 volts as suitable, from a relatively high voltage source, for example, a 110V or 240V electricity grid. Alternatively, the rack may supply the relatively low voltage and the mains supply omitted. There may be a DC regulator in the form of a switched mode power supply module 115 mounted to the printed circuit board 112 that receives the low voltage output from the mains supply 114 and powers two or more active conductive rails integral to the circuit board 112. Alternatively, the mains supply and DC regulator may be mounted within the enclosure separate from the printed circuit board 112.

At least one fan 116 may be mounted to the circuit board 112 or alternatively the enclosure. The at least one fan may provide airflow across the multilayer printed circuit board to extract waste heat.

The printed circuit board 112 may also have mounted thereto a management unit 119 comprising, in this but not necessarily all embodiments, an ARM processor communicating with serial or Ethernet interfaces 123 for receiving instructions via an Ethernet (or other) management network or other source, for example. The fault monitor 54 may be in connected to one of the interfaces 123. The management unit 119 may also control active indicia 125 in the form of LED status lights mounted at the front of the enclosure.

The architecture 100 has two ports 117 and 127, although other embodiments may have any number of ports. Each of the ports has a physical layer interface in the form of a transceiver, such as transceiver 118 of port 117. In this embodiment, but not necessarily in all embodiments, the plurality of transceivers comprise Small Form Factor Pluggable Plus (SFP+) transceivers. Other embodiments may use GBIC, XFP, XAUI transceivers, or generally any suitable transceivers. Alternative embodiments may use separate receivers and transmitters that are not integral to transceivers. The transceivers 118 are arranged to engage one or more received physical layer conduits in the form of external optical fibre network cables and/or copper network cables. The transceiver may send and receive electromagnetic communications in the form of at least one of an optical signal and an electrical signal. In this embodiment, the transceivers are each configured to receive two LC connectors terminating respective optical fibre cables that click into the transceiver, but any suitable connectors may be used. One of the optical fibers is for electromagnetic communications received by the transceiver, and communicates with a receiver of the transceiver, and the other is for electromagnetic communications sent by the transceiver and is connected to a transmitter of the transceiver. The transceivers generate electrical signals from the received optical signals, and subsequently communicate the electrical signals to the printed circuit board 12. The transceivers may support the gigabit Ethernet protocol and receive and/or transmit Ethernet packets, but other embodiments may have transceivers that support SONET, Fibre Channel, or any other suitable communications standard.

In this but not necessarily all architectures, one of the transceivers 129 in use receives a connector of an optical fibre network cable in communication with the network 18.

The transceivers may be housed in enclosures in the form of SFP cages 120 fixed to the printed circuit board 112. The cages provide an electrical connection between electrical contacts on the transceivers 118 and conductive tracks 122 in the form of stripline and/or micro stripline tracks formed on or within the circuit board 112. The cages may also act as Faraday cages to reduce electromagnetic interference, and extract heat from the transceiver. In alternative embodiments, the transceivers may be mounted directly to the printed circuit board.

The stripline 122 (which may be a micro-stripline, for example) provides a conduit for communications between the transceivers and a processor 124 comprising a logic device 126 in the form of a field programmable gate array (FPGA). In other embodiments, the logic device may be any suitable logic device such as a complex programmable logic device, and an application-specific integrated circuit (ASIC). In some embodiments, the networking componentry may comprise more than one logic device.

The field programmable array 126 may have any suitable architecture. In one embodiment, the FPGA architecture comprises an array of configurable logic blocks, I/O pins, and routing channels. Generally but not necessarily, the logic blocks comprise of logical cells that may comprise of, for example, a look up table, a full adder, and a D-type flip flop. Clock signals may be routed through special purpose dedicated clock networks within the FPGA in communication with a reference clock 133 mounted on the printed circuit board 112. The reference clock 133 has a frequency of 156.25 MHz, but other frequencies may be used as appropriate. The FPGA may also include higher-level functionality including embedded multipliers, generic digital signal processing blocks, embedded processors, high-speed I/O logic for communication with components external of the FPGA (for example), and embedded memories that may be used by buffers.

The internal structure of the FPGA is configured to form a plurality of modules. The modules may have features of corresponding modules in FIGS. 1, 5 and 6, or the functions of those later modules may be fragmented across more than one FPGA module. The modules are initially specified, for example, using a hardware description language, examples structure updater of which include HDL, VHDL and VERILOG. The functionality to be implemented in the FPGA is described in a hardware description language. The description is compiled, synthesized and mapped to the FPGA using appropriate EDA tools to a configuration file that, when loaded or programmed into the FPGA, causes the FPGA to implement the functionality described.

Generally, but not necessarily, the electromagnetic communications processed by the processor 10 comprise packets. The packets generally, but not necessarily, comprise, for example, a header, and a payload. The packets may also have a trailer. The electromagnetic communications may be structured in accordance with the Open Systems Interconnection Model, in which each payload may be itself another packet of another layer of the OSI model. For example, at the physical layer the packet is a collection of bits. The physical layer packet may comprise a data link packet having a datalink header, a datalink payload and a datalink trailer. The datalink payload may in turn comprise a Network data packet such as an IP packet. The IP packet payload may comprise a TCP or UDP packet (“segment”). This layered structure may continue to the Application layer.

While the network connections described above may comprise optical and/or electrical Ethernet (10 Mb, 40 Mb, 1 Gb, 10 Gb, 40 Gb, 100 Gb, 400 Gb, 1 Tb), it will be understood that other network types and protocols may be used, such as INFINIBAND and WiFi. Generally, any packet based protocol may be used. Alternatively or additionally, one or more of the network connections may alternatively be a serial port connection, a USB port connection, a FireWire™ port connection, a ThunderBolt™ port connection, a PCI or PCIe connection, a SONET (or SDH) connection with or without a sonnet demultiplexing device, or generally any suitable type of connection.

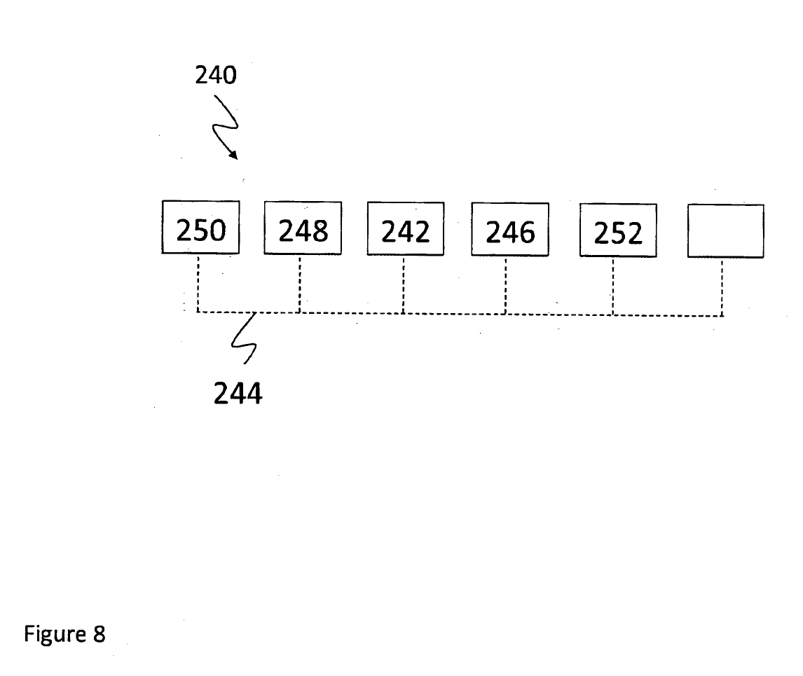

FIG. 8 shows a schematic diagram of another example a processor architecture 240 that the processor embodiments of FIGS. 1, 5 and 6 may have. The method of FIG. 2, for example, may be coded in a program for instructing the processor. The program is, in this embodiment, stored in nonvolatile memory 248 in the form of a hard disk drive, but could be stored in FLASH, EPROM or any other form of tangible media within or external of the processor. The program generally, but not necessarily, comprises a plurality of software modules that cooperate when installed on the processor so that the steps of the method of FIG. 2 is performed. The software modules, at least in part, correspond to the steps of the method or components of the system or processors described above. The functions or components may be compartmentalised into modules or may be fragmented across several software modules. The software modules may be formed using any suitable language, examples of which include C++ and assembly. The program may take the form of an application program interface or any other suitable software structure. The processor 240 includes a suitable micro processor 242 such as, or similar to, the INTEL XEON or AMD OPTERON micro processor connected over a bus 244 to a random access memory 246 of around 1 GB and a non-volatile memory such as a hard disk drive 248 or solid state non-volatile memory having a capacity of around 1 Gb. Alternative logic devices may be used in place of the microprocessor 242. Examples of suitable alternative logic devices include application-specific integrated circuits, FPGAs, and digital signal processing units. Some of these embodiments may be entirely hardware based for further latency reduction. The processor 240 has input/output interfaces 250 which may include one or more network interfaces, and a universal serial bus. The processor may support a human machine interface 252 e.g. mouse, keyboard, display etc.

Variations and/or modifications may be made to the embodiments described without departing from the spirit or ambit of the invention. The present embodiments are, therefore, to be considered in all respects as illustrative and not restrictive.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A processor for processing order information indicative of an order, the processor being arranged to generate executability information indicative of the executability of at least part of the order using the order information, send a response to the order, the response comprising the order executability information, and execute the at least part of the order if the order executability information indicates that the order is at least in part executable.

2. A processor defined by claim 1, the processor comprising:
an order executability determiner arranged to generate executability information indicative of the executability of at least part of the order using the order information;
a response sender arranged to receive the order executability information and send a response to the order, the response comprising the order executability information; and
an order executer arranged to receive the order executability information and arranged to execute the at least part of the order after the sending of the response if the order executability information indicates that the order is at least in part executable.

3. A processor defined by claim 2 comprising memory having a pending order data structure, the pending order data structure having pending order information indicative of a plurality of pending orders, wherein the order executability determiner is arranged to interrogate the pending order data structure to determine if the order can be matched with at least one of the plurality of pending orders.

4. A processor defined by claim 3 wherein the pending order data structure comprises a pending order queue, the pending order information being ordered to prioritise the pending orders.

5. A processor defined by claim 4 wherein the pending order data structure comprises a price index indicative of a plurality of possible order prices, the pending order data structure associates each of the plurality of pending orders to one of the plurality of possible order prices, the pending order data structure has a doubly linked list data structure having the pending order information, the doubly linked list comprises a plurality of nodes, each of the plurality of nodes being indicative of one of the plurality of orders, those of the nodes being indicative of identically priced orders may be grouped together.

6. A processor defined by any one of the claims 3 to 5 wherein the order executer is arranged to modify the pending order information.

7. A processor refined by any one of the preceding claims comprising an order information receiver arranged to receive the order information.

8. A processor comprising:
an order information receiver arranged to receive order information indicative of a plurality of orders; and
an order distributer and a plurality of sub processors, the order distributor being arranged to distribute the plurality of orders to the plurality of sub processors which are cooperatively arranged to concurrently processes the plurality of orders.

9. A processor defined by claim 8 wherein each of the sub processors comprise an order executability determiner arranged to determine the executability of one of the plurality of orders received thereby, each of the plurality of sub processors comprise a response sender arranged to send a response to the one of the plurality of orders received thereby, the response indicating that the one of the plurality of orders received thereby is at least in part executed and not executable, the processor comprising an order executer arranged to execute those of the plurality of orders that have been determined to be at least in part executable after sending of their respective response.

10. A processor defined by claim 8 wherein each of the plurality of sub processors comprise a processor defined by any one of the claims 1 to 8.

11. A system for processing order information indicative of a received order, the system comprising:
a plurality of processors each defined by any one of the claims 1 to 10; and
a processor fault monitor in communication with the plurality of processors, the processor fault monitor being arranged to detect a fault in one of the plurality of processors and subsequently enable at least one of the remaining of the plurality of processors.

12. A method for processing order information indicative of an order, the method comprising the steps of:
generating executability information indicative of the executability of at least part of the received order using the order information;
sending a response to the order, the response comprising order the executability information; and
executing the at least part of the order after sending the response if the order executability information indicates that the order is at least in part executable.

13. A method define by claim 12 comprising the step of generating executability information comprises the step of interrogating a pending order data structure having pending order information indicative of a plurality of pending orders to determine if the order can be matched with at least one of the plurality of pending orders.

14. A method defined by claim 13 wherein the pending order data structure comprises a pending order queue, the pending order information being ordered to prioritise the pending orders, the pending order data structure comprising a price index indicative of a plurality of possible order prices, the pending order data structure associating each of the plurality of pending orders to one of the plurality of possible order prices, the pending order data structure having a doubly linked list data structure having the pending order information, the doubly linked list comprising a plurality of nodes, each of the plurality of nodes being indicative of one of the plurality of orders, those of the nodes being indicative of identically priced orders may be grouped together.

15. A method defined by any one of the claims 12 to 14 comprising the step of modifying the pending order information to at least one of: modify the pending order information to remove indications therein of a pending order that has been match; and modify the pending order information to reduce the number of instruments indicated by one of the plurality of pending orders.

16. A method comprising the steps of:
receiving order information indicative of a plurality of orders; and
distributing the plurality of orders to the plurality of sub processors arranged to concurrently process the plurality of orders.

17. A method defined by claim 16 comprising determining the executability of the plurality of orders.

18. A method defined by claim 17 comprising sending a response to each of the plurality of orders, the response indicating that the respective order is at least in part executed and that the respective order is not executable.

19. A method defined by claim 18 comprising the step of executing each of the plurality of orders that have been determined to be at least in part executable after sending the respective response.

20. A method for processing order information indicative of a received order, the method comprising the steps of:
monitoring for a fault in one of a plurality of processors defined by any one of the claims 1 to 9; and
detecting a fault in the one of the plurality of processors and enabling at least one of the remaining of the plurality of processors.

21. A method defined by any one of the claims 12 to 20 comprising the step of receiving the order information.

22. Processor readable tangible media including program instructions which when executed by a processor causes the processor to perform a method defined by any one of the claims 12 to 21.

23. A computer program for instructing a processor, which when executed by the processor causes the processor to perform the method defined by any one of the claims 12 to 21.

24. A processor defined by any one of the claims 1 to 7 arranged to execute the at least part of the order after the sending of the response if the order executability information indicates that the order is at least in part executable.
